(19) United States
(12) Patent Application Publication
(10) Pub. No.: US 2014/0130388 A1
(43) Pub. Date: May 15, 2014

(54) INTERCHANGEABLE BUMPER DISPLAY

(71) Applicant: Kevin Paul McCormick, Brick, NJ (US)

(72) Inventor: Kevin Paul McCormick, Brick, NJ (US)

(21) Appl. No.: 14/038,979

(22) Filed: Sep. 27, 2013

Related U.S. Application Data
(60) Provisional application No. 61/724,565, filed on Nov. 9, 2012.

(51) Int. Cl. G09F 21/04

(52) U.S. Cl. CPC G09F 21/048
USPC 40/591

(57) ABSTRACT

An interchangeable bumper display is provided. The interchangeable bumper display may include a transparent front sheet and a magnetic rear sheet connected together forming a pocket and an opening to the pocket. A sheet having a design or message may be secured within the pocket. A user may then place the interchangeable bumper display on the rear of their vehicle. If the user would like to change the design or message, the user may remove the sheet and replace the sheet with a new sheet with a new design or message.

### CROSS-REFERENCE TO RELATED APPLICATION

This application claims the benefit of priority of U.S. provisional application No. 61/724,565, filed Nov. 9, 2012, the contents of which are herein incorporated by reference.

### BACKGROUND OF THE INVENTION

The present invention relates to interchangeable bumper display and, more particularly, to a transparent pocket that is releasably attachable to a vehicle.

Currently, if a user would like to display a picture or a message on their car, they must use a bumper sticker. However, a bumper sticker cannot easily be removed from the car. Therefore, the bumper sticker may become weathered and unappealing. Further, once a user is actually successful in removing the bumper sticker, the user cannot reuse it.

As can be seen, there is a need for a device for displaying pictures or messages from a vehicle that is reusable and easily removable.

### SUMMARY OF THE INVENTION

In one aspect of the present invention, an interchangeable bumper display comprises: a front sheet comprising a transparent material, wherein the front sheet comprises a front sheet edge; and a rear sheet comprising a magnetic material, wherein the rear sheet comprises a rear sheet edge, wherein the front sheet and the rear sheet are connected along a closed portion of the front sheet edge and the rear sheet edge, forming a pocket in between the front sheet and the rear sheet, wherein an opening to the pocket is formed along an open portion of the front sheet edge and the rear sheet edge.

In another aspect of the present invention, a method of placing a display on a bumper comprises: providing an interchangeable bumper display comprising: a front sheet comprising a transparent material, wherein the front sheet comprises a front sheet edge; and a rear sheet comprising a magnetic material, wherein the rear sheet comprises a rear sheet edge, wherein the front sheet and the rear sheet are connected along a closed portion of the front sheet edge and the rear sheet edge, forming a pocket in between the front sheet and the rear sheet, wherein an opening to the pocket is formed along an open portion of the front sheet edge and the rear sheet edge; placing a sheet comprising at least one of a design and a message through the opening and into the pocket of the interchangeable bumper display; and placing the magnetic material of the rear sheet onto the rear of a vehicle and thereby releasably attaching the interchangeable bumper display to the vehicle.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is an exploded view demonstrating pre-insertion of an exemplary bumper sticker;

FIG. 3 is a perspective view demonstrating post-insertion of the exemplary bumper sticker of FIG. 2;

FIG. 4 is a perspective view demonstrating folding over of a bumper sticker envelope flap; and

FIG. 5 is a section detail view of the present invention along line 5-5 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an interchangeable bumper display. The interchangeable bumper display may include a transparent front sheet and a magnetic rear sheet connected together forming a pocket and an opening to the pocket. A sheet having a design or message may be secured within the pocket. A user may then place the interchangeable bumper display on the rear of their vehicle. If the user would like to change the design or message, the user may remove the sheet and replace the sheet with a new sheet with a new design or message.

In certain embodiments, the present invention is an interchangeable bumper display that protects and attaches pictures or messages to a vehicle, refrigerator, locker and the like. The user may insert a sheet within the interchangeable bumper, such as a design or message. The user may attach the magnetic sheet to their car, and the present invention may protect the sheet from the elements. Further, the printed sheet may be removed from the envelope and a different sheet may be inserted into the envelope at any time. Different designs and messages can be easily printed, protected and displayed.

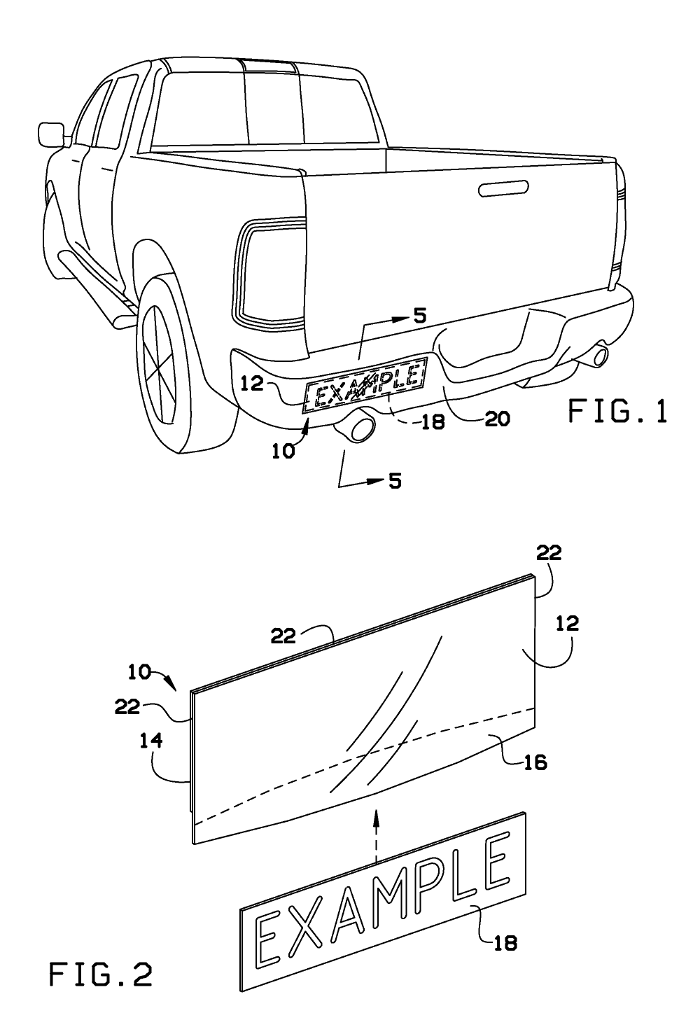

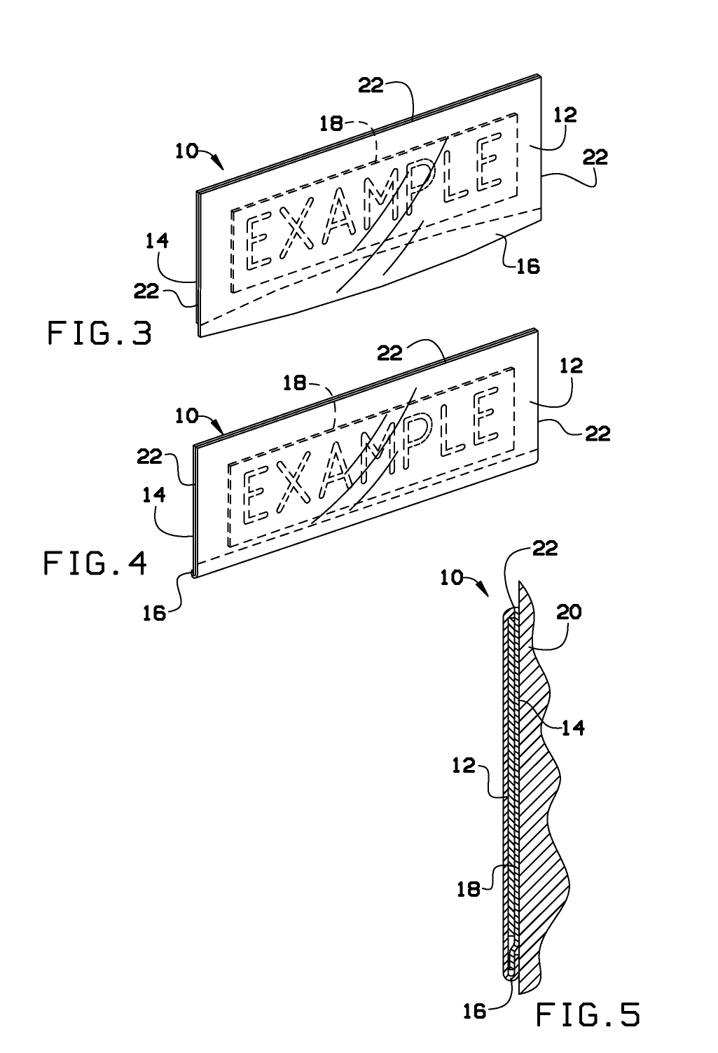

Referring to FIGS. 1 through 5, the present invention may include an interchangeable bumper display 10. The bumper display 10 may include a front sheet 12 and a rear sheet 14. The front sheet 12 may be made of a transparent material, and may include a front sheet edge 22. The rear sheet may include a magnetic material, and may include a rear sheet edge 22. The front sheet 12 and the rear sheet 14 may be connected along a closed portion of the front sheet edge 22 and the rear sheet edge 22 forming a pocket in between the front sheet 12 and the rear sheet 14. An opening to the pocket may be formed along an open portion of the front sheet edge 22 and the rear sheet edge 22 where the front sheet edge 22 and the rear sheet edge 22 are not connected.

In certain embodiments, the bumper display 10 may have four sides along the edge 22 forming a rectangular shape, similar to an envelope. In such embodiments, one of the sides may not be connected to form the opening. The four sides may include a top side, a bottom side, a first side and a second side. In certain embodiments, the top side or the bottom side may form the opening. A distance from the top side to the bottom side of the front sheet 12 may be longer than a distance from the top side to the bottom side of the rear sheet 14 forming a flap 16 at the bottom side of the front sheet 12. As illustrated in FIG. 5, the flap 16 may be folded over the bottom side edge 22 of the rear sheet 14, thereby closing off the opening.

In certain embodiments, the transparent front sheet 14 may be a clear polymer, such as, but not limited to, a clear vinyl sheet or plastic sheet. The rear sheet 14 may be a magnetic sheet. However, in certain embodiments, the rear sheet 14 may be made of a similar material as the front sheet 12 with magnets attached to the rear sheet 14. A sheet 18 may be placed within the pocket of the bumper display 10. The sheet 18 may include, but is not limited to, print outs, bumper stickers, decorations, pictures, and anything that a user would like to display from the envelope with any designs and/or messages. For example, a user may print an item from their printer on a sheet of paper and place the sheet of paper in the envelope.

A method of using the present invention may include the following. The interchangeable bumper display 10 disclosed above may be provided. A user may place a bumper sticker sheet 18 through the opening and into the pocket of the interchangeable bumper display 10. The user may then place the magnetic material of the rear sheet 14 onto the rear of a vehicle 20, and thereby releasably attaching the interchangeable bumper display to the vehicle 20.

It should be understood, of course, that the foregoing relates to exemplary embodiments of the invention and that modifications may be made without departing from the spirit and scope of the invention as set forth in the following claims.

What is claimed is:

1. An interchangeable bumper display comprising:
a front sheet comprising a transparent material, wherein the front sheet comprises a front sheet edge; and
a rear sheet comprising a magnetic material, wherein the rear sheet comprises a rear sheet edge,
wherein the front sheet and the rear sheet are connected along a closed portion of the front sheet edge and the rear sheet edge, forming a pocket in between the front sheet and the rear sheet, wherein an opening to the pocket is formed along an open portion of the front sheet edge and the rear sheet edge.

2. The interchangeable bumper display of claim 1, wherein the front sheet and the rear sheet comprises four sides along the front sheet edge and the rear sheet edge, wherein three of the sides are connected and one of the sides forms the opening.

3. The interchangeable bumper display of claim 2, wherein the four sides comprises a top side, a bottom side, a first side, and a second side.

4. The interchangeable bumper display of claim 3, wherein the bottom side comprises the opening.

5. The interchangeable bumper display of claim 4, wherein a distance from the top side to the bottom side of the front sheet is longer than a distance from the top side to the bottom side of the rear sheet forming a flap at the bottom side.

6. The interchangeable bumper display of claim 5, wherein the flap is folded over the rear sheet edge covering the opening.

7. The interchangeable bumper display of claim 1, wherein the rear sheet is a magnetic sheet.

8. The interchangeable bumper display of claim 1, further comprising a bumper sticker within the pocket.

9. A method of placing a display on a bumper comprising:
providing an interchangeable bumper display comprising: a front sheet comprising a transparent material, wherein the front sheet comprises a front sheet edge; and a rear sheet comprising a magnetic material, wherein the rear sheet comprises a rear sheet edge, wherein the front sheet and the rear sheet are connected along a closed portion of the front sheet edge and the rear sheet edge, forming a pocket in between the front sheet and the rear sheet, wherein an opening to the pocket is formed along an open portion of the front sheet edge and the rear sheet edge;
placing a sheet comprising at least one of a design and a message through the opening and into the pocket of the interchangeable bumper display; and
placing the magnetic material of the rear sheet onto the rear of a vehicle and thereby releasably attaching the interchangeable bumper display to the vehicle.
